(19) United States
(12) Patent Application Publication
(10) Pub. No.: US 2002/0146303 A1
(43) Pub. Date: Oct. 10, 2002

(54) Wafer handling system and apparatus

(76) Inventor: Woo Sik Yoo, Palo Alto, CA (US)

Correspondence Address: SKJERVEN MORRILL LLP, 25 METRO DRIVE, SUITE 700, SAN JOSE, CA, 95110, US

(21) Appl. No.: 09/828,659

(22) Filed: Apr. 6, 2001

(51) Int. Cl. B65G 49/07

(52) U.S. Cl. 414/217

(57) ABSTRACT

An object handling system and apparatus for moving objects through a pressure sensitive system. The present invention can operate in a chamber having a pressurized environment, without adversely influencing or causing pressure changes. The present invention can be used in the transfer chamber of a semiconductor processing system, which has vertically mounted (i.e., vertically integrated) multiple reactors, load locks, and cooling stations, and which requires substantial vertical movement of the handling system. The handling system of the present invention includes a handling mechanism operatively coupled to a robotic device, which is mounted to a driver member. The driver member is movably secured at opposite ends of the chamber in which it operates. The robotic device can translate along the driver member and extend the handling mechanism in the horizontal plane to grab or pick-up an object and move the object to an alternative location.

### BACKGROUND OF THE INVENTION

1. Field of the Invention

This invention generally relates to semiconductor device fabrication, and more particularly, to an object handling system and apparatus for moving objects through a pressure sensitive system.

2. Related Art

Specialized wafer processing systems used to process semiconductor wafers into electronic devices is well known. Because floor space in a semiconductor fabrication clean-room and equipment area is typically scarce and costly, it is highly desirable to have a wafer processing system which occupies minimal floor space. One solution is to have a vertically oriented wafer processing system, which has vertically mounted modules or chambers, because such a system can be operated in a small contiguous area.

A vertically oriented wafer processing system typically employs a robot to automate the movement of wafers between the vertically arranged modules. In most of these types of systems, the robot is mounted atop a post-like drive member inside a transfer chamber. The post-like drive member moves in and out of the transfer chamber to move the robot in a vertical direction within the processing system. In this example, the movement of the robot and post-like drive member can be compared to the movement of a piston. Unfortunately, as the post-like drive member operates the space (i.e., volume) being occupied by the robot increases as the robot is raised and decreases as the robot is lowered. The variableness of the occupied volume can cause pressure changes to occur in the processing system.

Pressure changes can be undesirable in the processing system, since some processing recipes are optimized to work at a specific pressure (and/or temperature). Pressure changes can also create contamination control problems, since a pressure imbalance may cause contaminants to more readily enter the processing system.

For these reasons, what is needed is a system and apparatus for handling and transporting an object in a processing system, and which does not adversely influence the pressure environment within the processing system.

### SUMMARY

In accordance with the present invention, a handling system and apparatus can operate in a processing system having a pressurized environment, without adversely influencing or causing pressure changes. In one example of the present invention, the handling system and apparatus can be used in a semiconductor processing system having vertically mounted multiple modules (i.e., vertically integrated chambers), which can include reactors, load locks, and cooling stations, since these processing systems can require substantial vertical movement of the handling system.

As described in greater detail below, the handling system of the present invention includes a handling mechanism operatively coupled to a robotic device, mounted to a driver member. The driver member is slidably secured at opposite ends to a top and a bottom portion of a chamber in which it operates. In this arrangement, the handling mechanism, the robotic device, and the driver member are fully enclosed in the chamber during a typical operation. In one example, the vertical movement allows the handling mechanism to access the vertically mounted reactors, load locks, cooling stations, and other modules of the semiconductor processing system. Once the robotic device reaches a desired vertical position, the handling mechanism can extend in the horizontal plane to grab or pick-up an object and can then be rotated to move the object to an alternative location.

Accordingly, the handling system consistently occupies a predetermined volume of space within the chamber. Thus, as the handling system is raised, lowered, extended or rotated to transport an object, the volume of space occupied by the handling system remains constant. Accordingly, for a given pressure sensitive operation occurring within the processing system, movement of the handling system of the present invention causes substantially little or no pressure change or fluctuation.

The present invention provides a simple design with numerous advantages, especially for semiconductor wafer processing systems. For example, since the volume of space in the processing system occupied by the handling system is constant, pressure fluctuation caused by movement of the handling device is reduced or eliminated. The reduction or elimination of pressure fluctuations causes fewer disturbances to the processing operations. The configuration of the present invention also lowers the opportunity for particle migration into the processing system, which can cause contamination of the wafer processing operation. Thus, various pressure sensitive wafer processing recipes can be applied more accurately and more uniformly to wafers.

Other uses, advantages, and variations of the present invention will be apparent to one of ordinary skill in the art upon reading this disclosure and accompanying drawings.

### BRIEF DESCRIPTION OF THE DRAWINGS

FIGS. 1A and 1B show a side view and a top view, respectively, of a wafer processing system in accordance with the invention;

FIG. 2 is a simplified diagram of a wafer handling system in accordance with the present invention;

FIGS. 3A and 3B are simplified illustrations of alternative embodiments in accordance with the present invention; and

FIGS. 4A-4F are simplified illustrations of side views of the wafer processing system shown in FIG. 1A illustrating the movement of a wafer from a carrier in a load lock to a reactor using the wafer handling system of FIG. 2.

### DETAILED DESCRIPTION

Although the system and apparatus of the present invention may be used as part of any pressure sensitive system, the embodiments described below generally disclose a semiconductor processing system. It should be understood that these embodiments are exemplary and their disclosure is not intended to limit the invention thereby.

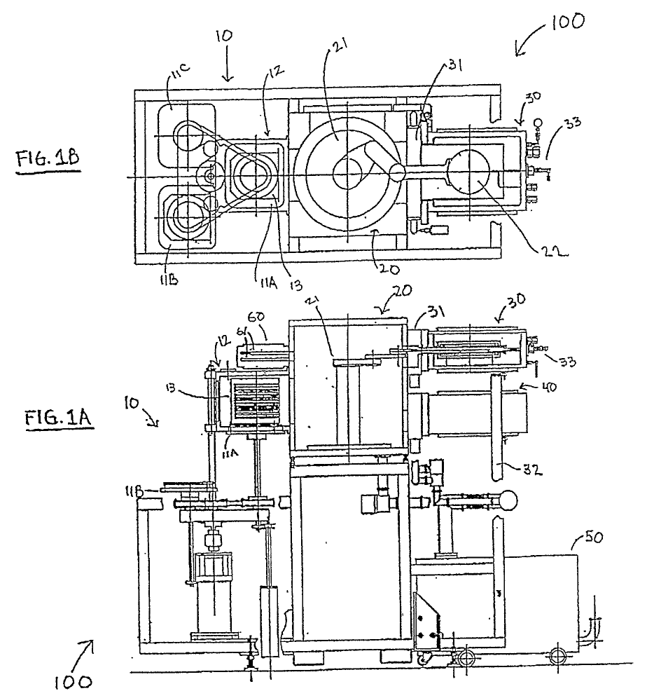

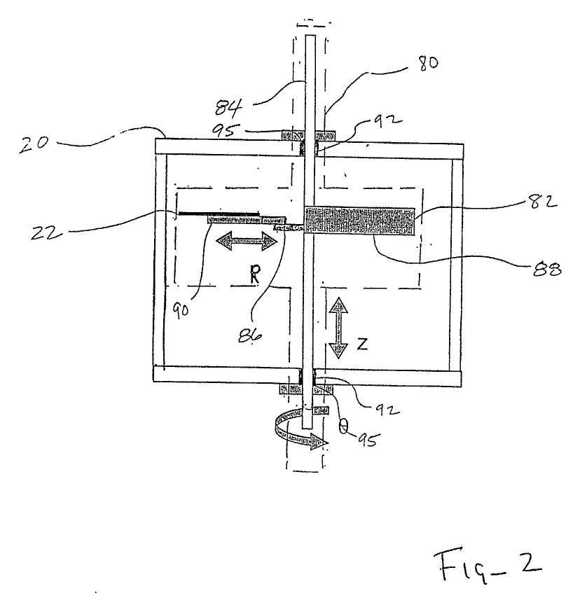

FIGS. 1A and 1B show a side view and a top view, respectively, of a wafer processing system 100, which provides a representative environment for the use of the present invention. A processing system of the type of system 100 is fully disclosed and described in commonly assigned U.S. patent application Ser. No. 09/451,677, filed Nov. 30, 1999, which is herein incorporated by reference for all purposes. System 100 includes a loading station 10, a load lock 12, a transfer chamber 20, a robot 21, reactors 30 and 40, and a cooling station 60. Loading station 10 has platforms 11A, 11B, and 11C for supporting and moving wafer carriers, such as a wafer carrier 13, up into load lock 12. While three platforms are used in this embodiment, the invention is not so limited. Two platforms can also be used as can additional platforms to increase throughput. Carrier 13 is a removable wafer carrier which can carry up to 25 wafers at a time. Other types of wafer carriers, including fixed wafer carriers, can also be used. Wafer carriers are loaded onto platforms 11A, 11B, and 11C either manually or by using automated guided vehicles (“AGV”).

While the movement of a wafer carrier into load lock 12 is illustrated herein using carrier 13 on platform 11A as an example, the same illustration applies to the movement of other wafer carriers using platforms 11B and 11C. Further, because platforms 11A, 11B, and 11C are structurally and functionally the same, any reference to platform 11A also applies to platforms 11B and 11C.

The rotational movement of platforms 11A, 11B, and 11C into position 2 minimizes the floor space occupied by loading station 10. Loading station 10 occupies just enough area to accommodate the number of platforms used, for example, three.

Referring to FIG. 1A, in this embodiment, reactors 30 and 40 are rapid thermal processing (“RTP”) reactors. However, the invention is not limited to a specific type of reactor and may use any semiconductor processing reactor such as those used in physical vapor deposition, etching, chemical vapor deposition, and ashing. Reactors 30 and 40 may also be of the type disclosed in commonly assigned U.S. patent application Ser. No. 09/451,494, filed Nov. 30, 1999, entitled “Resistively Heated Single Wafer Furnace,” which is incorporated herein by reference in its entirety. Reactors 30 and 40 are vertically mounted to save floor space. Process gases, coolant, and electrical connections are provided through the rear end of reactors 30 and 40 using interfaces 33.

A pump 50, shown in FIG. 1A, is provided for use in processes requiring vacuum. In the case where the combined volume of reactors 30 and 40 less than the combined volume of load lock 12, cooling station 60, and transfer chamber 20, a single pump 50 may be used to pump down the entire volume of system 100 (i.e. combined volume of load lock 12, cooling station 60, transfer chamber 20, reactor 30, and reactor 40) to vacuum. Otherwise, additional pumps such as pump 50 may be required to separately pump down reactors 30 and 40.

After wafer 22 is processed in a well known manner inside reactor 30 (or 40), gate valve 31 opens to allow robot 21 to move wafer 22 into cooling station 60 (FIG. 1A). Because newly processed wafers may have temperatures upwards of 200° C. and could melt or damage a typical wafer carrier, cooling station 60 is provided for cooling the wafers before placing them back into a wafer carrier in load lock 12. In this embodiment, cooling station 60 is vertically mounted above load lock 12 to minimize the floor space area occupied by system 100. Cooling station 60 includes shelves 61, which may be liquid-cooled, to support multiple wafers at a time. While two shelves are shown in FIG. 1A, of course, a different number of shelves can be used, if appropriate, to increase throughput.

Subsequently, wafer 22 is picked-up from cooling station 60 and replaced to its original slot in carrier 13 using robot 21. Platform 11A lowers from load lock 12 and rotates out of position to allow another platform to move a next wafer carrier into load lock 12.

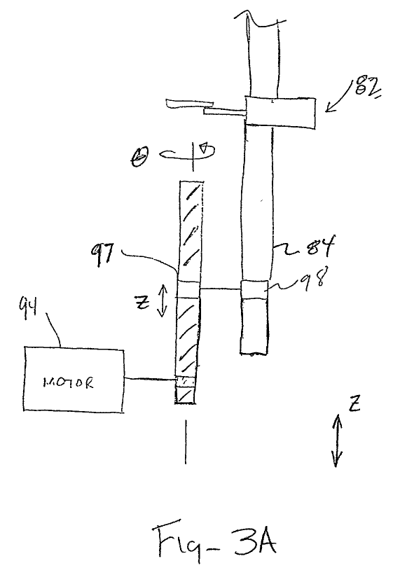

FIG. 2 shows an embodiment of transfer chamber 20, which includes wafer handling system 80, an alternative to robot 21 (FIG. 1A). As described in more detail below, wafer handling system 80 is disposed in wafer transfer chamber 20 to transport wafer 22 from a wafer carrier to a reactor or other processing chamber. Wafer handling system 80 includes a wafer handling mechanism 82 and a driver member 84. Wafer handling mechanism 82 can include a robot arm 86 operably coupled to a linear movement actuator 88. Typically, at the end of robot arm 86 is an end effector 90 for picking up and/or grabbing wafer 22.

In one embodiment, driver member 84 is arranged, such that opposing ends of driver member 84 are held in a sliding relationship with transfer chamber 20. Advantageously, by mounting driver member 84 in sliding arrangement with the top and bottom opposed ends of transfer chamber 20, the need for additional linear guides, typically used to prevent wobble and increase stability, are reduced or eliminated. Since driver member 84 is supported at both ends, driver member 84 can be made relatively narrow and still remain stiff. The actual specification for drive member 84 is determined by the actual application (i.e., the size of the process chamber and handling mechanism). For example, in one embodiment, driver member 84 may have a diameter of between about 10 mm and 50 mm; preferably 20 mm. Accordingly, driver member 84 can be made of any high strength structural material, such as steel, aluminum and the like.

In one embodiment, driver member 84 is a smooth cylindrical shaft that can be driven linearly in direction Z through bearings 92 to move driver member 84 up or down. In this embodiment, a top portion of driver member 84 is mounted through the top of transfer chamber 20 through a combination of a roller bearing 92 and a seal 95 (collectively “sealable bearing 92”) or similarly functioning bearing/seal combination that provides smooth linear translation in direction Z and smooth rotation in direction θ. A bottom portion of driver member 84 is similarly using roller bearing 92 mounted through the bottom of transfer chamber 20. Bearings 92 are well known and the function of bearings is well understood by those of ordinary skill in the art. Seals 95 ensure that the internal environment of transfer chamber 20 and/or system 100 is unaffected by the movement of driver member 84. Seals 95 can be any type of seal which does not expand and compress with a moving part being moved therethrough. For example, seals 95 can be o-rings, lip-seals, or t-seals, such as the type of seals available from Sierracin Corporation of Sylmar, Calif.

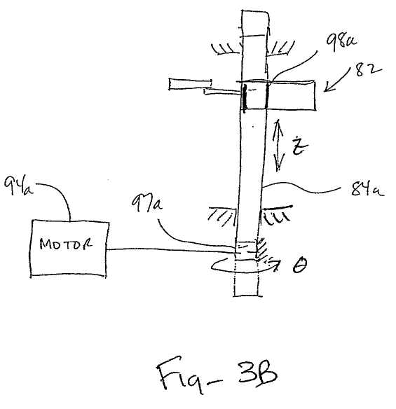

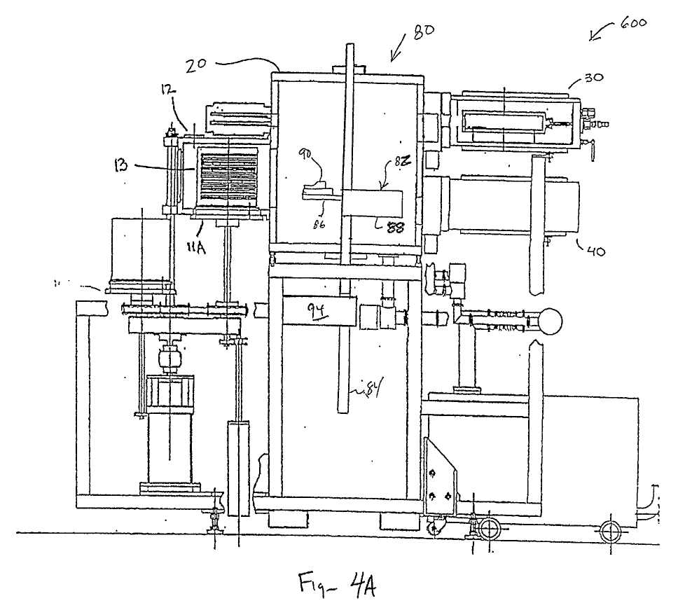

As shown in FIG. 3A, a direction Z (i.e., vertical motion) motor/controller 94 (hereinafter “driver motor”), can be used to cause driver member 84 to move in the Z and θ directions. Drive motor 94 may be any typical drive motor, such as is available from Yaskawa Electric of Fukuoka, Japan. In this embodiment, driver motor 94 may be mechanically coupled to a lead screw or worm drive 96 via a belt or similarly conventional power transmission means. A collar 97 is operably coupled to lead screw 96, and is attached to a corresponding collar 98, which is fixedly attached to driver member 84. As lead screw 96 rotates, collar 97 rides up (or down) on lead screw 96, causing collar 98 to move driver member 84 up (or down). In this manner, handling mechanism 82 may be raised/lowered as much as desired, for example, between a range of about 250 mm or greater; preferably about 350 mm.

Optionally, as shown in FIG. 3B, driver member 84a may be a threaded member, which can operate as a worm drive or lead screw drive. In this embodiment, driver motor 94a may be mechanically coupled directly to threaded driver member 84a via a belt system, a gear system or similarly conventional power transmission means. A collar 98a is operably coupled to handling mechanism 82, such that as driver member 84a rotates θ, collar 98a rides up (or down), causing handling system 82 to move up (or down) in the Z direction.

Movement of handling mechanism 82 in the horizontal direction is accomplished by extending robot arm 86 with end effector 90 attached thereto. End effector 90 can be made of any heat resistant material, such as quartz, for picking-up and placing wafer 22. End effectors and robot arms are well known and their function well understood by those of ordinary skill in the art.

Robot arm 86 and end-effector 90 are operably coupled to a linear movement actuator 88. For example, the extension and retraction of robot arm 86 and end effector 90 along a straight line can be accomplished using a conventional belt and pulley arrangement operably coupled to a linear motor. In one embodiment, the entire handling mechanism 82 can rotate θ relative to driver member 84 using a rotation motor. The rotation and linear motors are available from Yaskawa Electric.

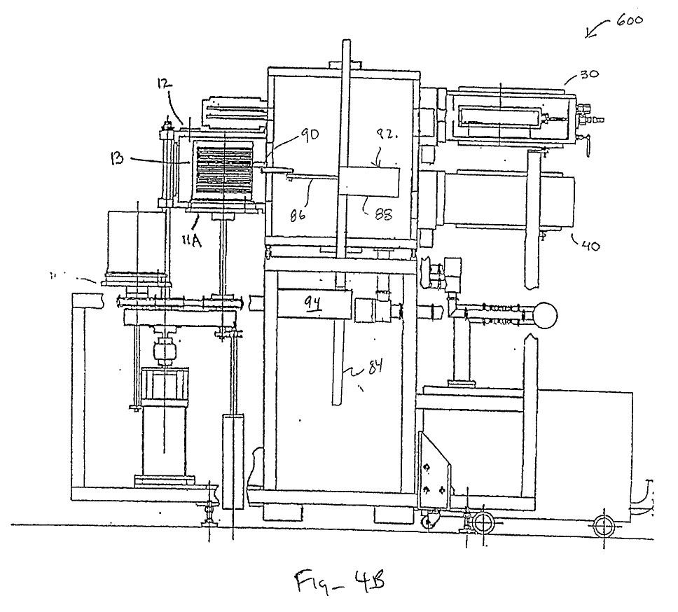

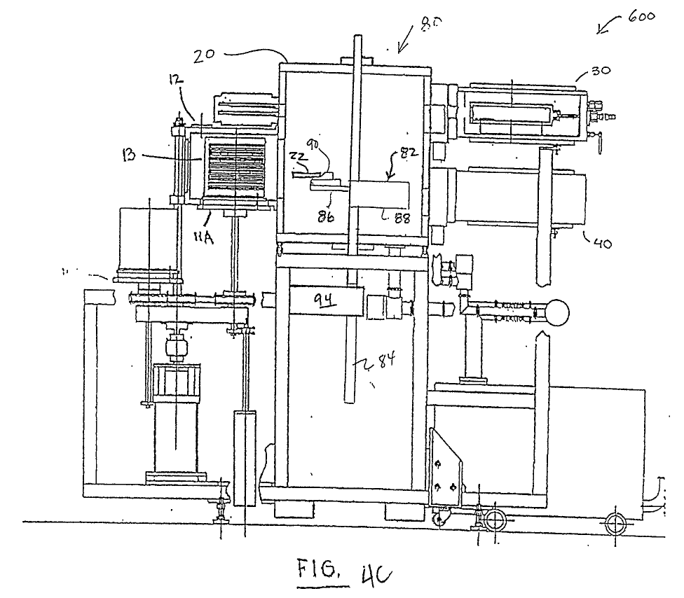

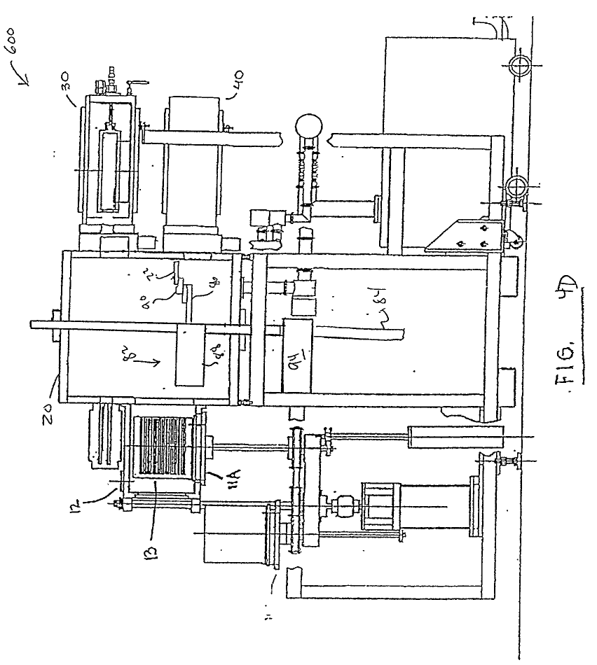

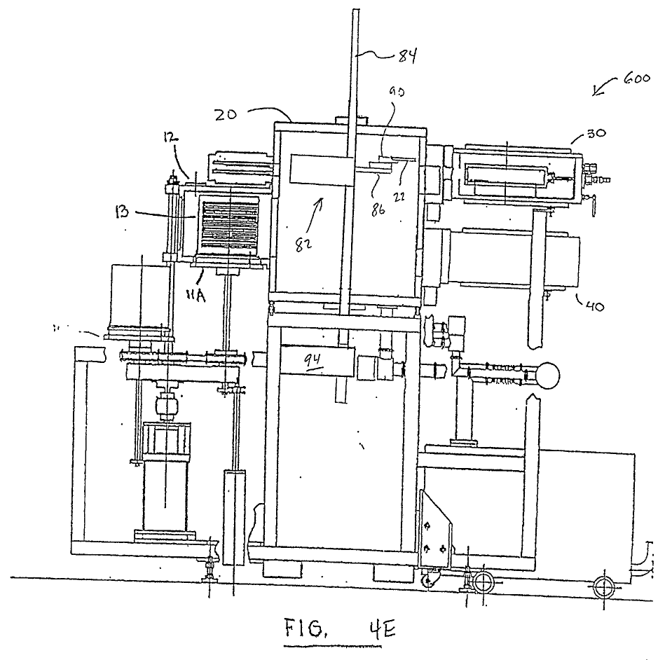

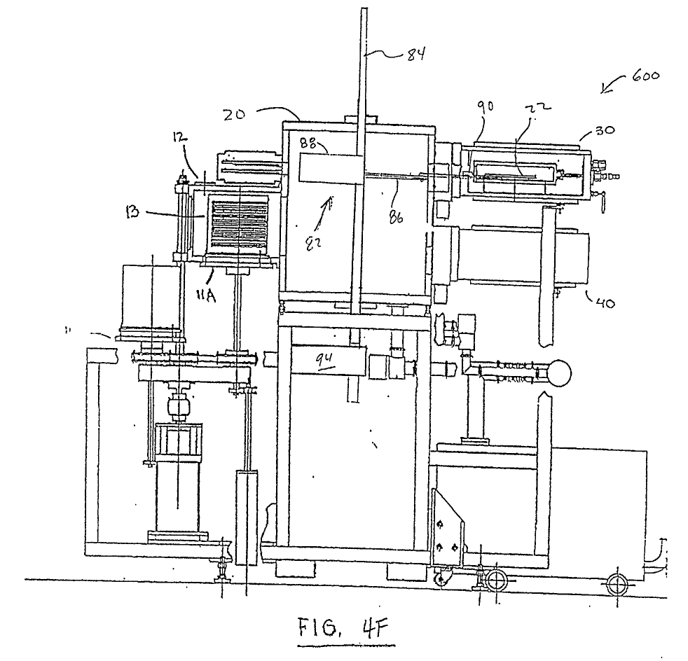

FIGS. 4A to 4F show side views of system 600 illustrating the movement of wafer 22 from carrier 13, which is inside load lock 12, to a reactor 30 (or 40). Once carrier 13 is inside load lock 12, handling system 80 in transfer chamber 20 rotates and lowers towards load lock 12 (FIG. 4A). Handling mechanism 82 extends robot arm 86 and end-effector 90 to pick up wafer 22 from wafer carrier 13 (FIG. 4B). Robot arm 86 then retracts and rotates towards reactor 30 (FIGS. 4C and 4D). Drive motor 94 causes driver member 84 to elevate, which, in turn, causes wafer handling mechanism 82 to position wafer 22 in-line with reactor 30 (FIG. 4E). Robot arm 86 then extends, such that end-effector 90 places wafer 22 into reactor 30 (FIG. 4F). Robot arm 86 then retracts and, subsequently, the processing of wafer 22 begins.

The description of the invention given above is provided for purposes of illustration and is not intended to be limiting. The invention is set forth in the following claims.

What is claimed is:

1. An object handling system comprising:
a housing defining an internal volume; and
a handling mechanism occupying a predetermined portion of said internal volume, said handling mechanism being movable within said housing such that said predetermined portion of internal volume occupied by said handling mechanism remains constant.

2. The wafer handling system of claim 1, wherein said housing comprises a wafer transport chamber.

3. The wafer handling system of claim 1, wherein said handling mechanism is a robot including capable of extension, rotational, and vertical motion.

4. The wafer handling system of claim 1, wherein said housing comprises a wafer transfer chamber which is a component of a wafer processing system further comprising a first reactor, a cooling station, and a load lock.

5. The wafer handling system of claim 4, further comprising a second reactor which is vertically mounted with respect to said first reactor.

6. The wafer handling system of claim 1, wherein said handling mechanism comprises a robot operably mounted to a member, said member being movably mounted at a first location and at a second location on said housing.

7. The wafer handling system of claim 1, wherein said housing is under a pressure, said pressure remaining constant as said handling mechanism is moved in said housing.

8. The wafer handling system of claim 1, wherein said handling mechanism moves an object comprising a semiconductor wafer.

9. A wafer transport apparatus for use in a wafer processing system, said transport apparatus comprising:
a robot arm;
a robot body; and
a driver member movably engaged at a top end and a bottom end of a chamber, said robot arm and said robot body being movable along said driver member.

10. The apparatus of claim 9, wherein said chamber comprises a wafer transfer chamber operably coupled to a process chamber, wherein each of said chambers is under a pressure, and wherein said pressure remains constant during movement of said robot arm, said robot body, and said driver member.

11. The apparatus of claim 9, wherein said chamber comprises an arrangement of a wafer transfer chamber operably coupled to a processing chamber, each of said chambers being in communication together to define a first volume, wherein said robot arm, said robot body, and said driver member occupy a second volume, wherein a ratio between said first volume and said second volume remains constant during movement of said robot arm, said robot body, and said driver member.

12. The apparatus of claim 9, wherein said robot arm is configured to move a semiconductor wafer to a process chamber.

13. The apparatus of claim 9, wherein said robot arm is capable of being extended, rotated, and raised vertically.

14. The apparatus of claim 9, wherein said driver member is rotatable.

15. A wafer processing system comprising:
a loading station;
a reactor, said loading station and said reactor under a pressure; and
means for moving a semiconductor wafer from said loading station to said reactor without causing said pressure to change substantially.
